(19) United States
(12) Patent Application Publication
(10) Pub. No.: US 2009/0188141 A1
(43) Pub. Date: Jul. 30, 2009

(54) Trapped doorz for securing brand/trade/logo marks to apparel or footwear

(76) Inventors: Juanita Asbery, Orangeburg, SC (US); Gregory Asbery, Orangeburg, SC (US)

Correspondence Address: Aleksandr Smushkovich, POB 140505, Brooklyn, NY, 11214, US

(21) Appl. No.: 12/011,660

(22) Filed: Jan. 29, 2008

(51) Int. Cl. G09F 19/00; G09F 21/02

(52) U.S. Cl. 40/586; 40/535

(57) ABSTRACT

A body article combinable with a piece of clothing, footwear, etc., displays indicia, such as signs/logos/brands/trademarks, comprising an opening with counterpart door locking means attached to the opening's edge, hinge means attached to the opening's edges, a door member attached to the hinge means and capable of opening inside the body article. The door member includes door locking means attached to its outer face and aligned with the counterpart door locking means enabling their releasable coupling, and indicia holding means attached to its outer face. The article comprises an indicia bearing plate including counterpart indicia holding means attached to its inward face, and aligned with the indicia holding means enabling their releasable coupling; and indicia means disposed on its outward face for display. A modified embodiment comprises the indicia means directly disposed on the outer face of door member that is releasably coupled to the hinge means.

### TECHNICAL FIELD

The present invention relates to the making and using articles as indicia carriers, for example, as carriers for advertising and/or brand/trade/logo marks, or three-dimensional items, particularly, to functional designs and methods of securing such articles to apparel, footwear, accessories, rugs, drapes, curtains, scarves, etc.

### BACKGROUND OF THE INVENTION

A multitude of indicia carriers are known in the prior art, including various articles, and parts thereof. For example, advertisements and brand/trade/logo marks are placed on commercial signs, posters, trucks, industrial machines, buildings' walls, paper (not only newspapers and books, but also cash-register ribbons, wall-paper, etc.), paper tissue (e.g. paper towels, toilet tissue), bags, packaging, cardboards, clothing (e.g. T-shirts, jackets, etc.), footwear, and so on.

Particularly, U.S. Pat. No. 6,729,058 to Ferguson teaches “An apparel mounted picture securing and displaying apparatus is provided having a lower support member with a corner attachment orifice formed at each corner point. An upper frame element forming a transparent retention means within an outer perimeter is attached to the lower support member.”

Another U.S. Pat. No. 4,536,975 to Harrell describes “An improved detachable pocket assembly for carrying I.D. cards, photos, coins, keys, tickets and the like on apparel such as shoes includes a pocket formed between front and back faces of sheet material, one of which faces preferably has a transparent plastic window sealed over an opening in it. The pocket can be pivoted in order for the wearer to look into it when wearing it on a shoe. The pocket has at the upper end an opening for access to contents, covered by a first extension at the top of the front face, folds over in a rearward and downward direction for rain shedding and has provision for securing the pocket to apparel, in the form of a strap-like extension from the bottom of the pocket that wraps around the pocket and detachably secures by snaps intermediate the back of the pocket and on the front of the pocket. These snaps or equivalent fasteners provide a securance for holding closed the fold over extension closed, and a backup securance for holding it positively to a shoe when the pocket is open and being pivoted, pushed or pulled for manipulating the contents; keyring can be carried by the detached pocket assembly.”

U.S. Pat. No. 4,852,276 to Savoca et al teaches: “The present invention is a shoe comprising a quarter panel over a part of which an outer material is secured so as to form a frame or opening positioned at the side of the shoe. An insert, such as a design or logo, is reversibly secured within said frame by a pressure sensitive adhesive. The insert is further held in place by a flexible lip formed by the outer material which overlaps the edges of the insert material.”

Yet, another U.S. Pat. No. 6,115,948 to Mitchell describes: “The present invention relates to articles of clothing and footwear and more particularly to an insertable patch or emblem which fits under the overlapping layer of a pocket formed in the article of clothing or footwear. The patch or emblem and the pocket in the article include releasable attachment means.”

This invention is dedicated to further widening the variety of types of displayable articles, and their attachment means to apparel, footwear, accessories, rugs, drapes, curtains, scarves, etc., herein further called “body articles”, which enables the body articles to display advertisement and/or brand/trade/logo marks, or three-dimensional items. The present invention allows users to create a unique diversity of various patterns for display on the body articles.

### SUMMARY OF THE INVENTION

While the structural arrangements of the above described prior art articles and many others, at first appearance, have similarities with the present invention, they differ in material respects. These differences, which will be described hereinafter, are essential for the designing, manufacturing, and effective use of the present invention.

This invention proposes “Trap Doorz”, that is a functionally designed article bearing an advertisement sign and/or a brand/trade/logo mark, or three-dimensional items thereon, which article can be combined with a piece of clothing or attire (including hats, fitted caps, jackets, jeans, etc.), footwear (boots, sneakers, etc.), accessories, bags, back packs, rugs, drapes, curtains, scarves, or the like. The “Trap Doorz” gives one the ability to interlock patterns of any of the above-enumerated and other items.

The “Trap Doorz” can utilize Velcro™ or the like material to provide the aforesaid interlocking. Alternatively, conventional fasteners can be employed, such as snaps, hooks and loops, etc. For illustrative purposes, a fitted baseball cap may display a logo of a baseball team on the frontal lobe portion of the cap. Typically, a fitted cap (example of a body article) is completely stitched throughout its body. According to an embodiment of the invention, the frontal portion, that bears the logo, is performed as a door-like member made of the body's material, such as fabric, etc.

The door member can open inside the cap leaving a squared opening in the cap's body, and is pivotally attached to one of the opening's side. For this purpose conventional hinge means made of suitable material can be utilized. Alternatively, bendable strips made of fabric, or leather, or the like can be stitched both to the edge of the opening and to the door member, forming ‘soft hinges’. The “Trap Doorz” is furnished with a predetermined number of first fasteners, e.g. pressure sensitive adhesive material strips (such as Velcro™ strips), male snaps, or other analogous fasten means, peripherally situated on its outer face, herein further called ‘door locking means’.

Counterpart fasteners (similar adhesive strips, or female snaps, or the like), herein called ‘counterpart door locking means’, are disposed on the body article peripherally and proximate to the edge of the aforesaid opening, aligned with the door locking means.

An indicia bearing plate (that can be made of the same body material, or optionally of another suitable material) is provided. On the front face of the plate, symbols, images, etc. can be placed, containing aforesaid advertisement signs and/or brand/trade/logo marks, or three-dimensional items. In this example, the indicia bearing plate is a logo plate. The logo plate is furnished with a predetermined number of second fasteners, e.g. pressure sensitive adhesive material strips (such as Velcro™ strips), male snaps, or other analogous fasten means, situated on its back face, herein further called ‘indicia holding means’.

The door member is also furnished with a predetermined number of counterpart second fasteners, e.g. pressure sensitive adhesive material strips (such as Velcro™ strips), female snaps, or other analogous fasten means, situated on its outer face closer to the center of the door member than the door locking means. The second fasteners are herein called ‘counterpart indicia holding means’ and aligned with the indicia holding means. Depressing these two against each other, one can couple the indicia holding means with the counterpart indicia holding means and thereby lock the door member to the opening of the body article in a closed state.

“Trap Doorz” can be opened by unlocking the door locking means, detaching three sides of the door member from the opening, and bringing the door member into an open state. In the open state, one can replace the first logo plate with a second logo plate (or different insignia, e.g. replace ‘Mets’ with ‘Yankees’, etc.) by detaching the indicia holding means of the first logo plate from the counterpart indicia holding means of the door member, and attaching the indicia holding means of the second logo plate to the counterpart indicia holding means of the door member. Then one closes the “Trap Doorz”, and it's locked with the aforesaid door locking means in the closed state.

### BRIEF DESCRIPTION OF DRAWINGS

FIG. 1 illustrates an external general isometric view of a body article (snicker) with an opening, made according to a preferred embodiment of the invention.

FIG. 2a illustrates an external isometric view of the body article with the opening and open “Trap Doorz”, according to the embodiment shown on FIG. 1.

FIG. 2b illustrates an isometric view of the “Trap Doorz”, with fasten means, according to the preferred embodiment shown on FIG. 1.

FIG. 3a illustrates an isometric view of the front face of the indicia bearing plate with fasten means, according to the preferred embodiment shown on FIG. 1.

FIG. 3b illustrates an isometric view of the back face of the indicia bearing plate with fasten means, according to the preferred embodiment shown on FIG. 1.

FIG. 4 illustrates an internal isometric view of the body article with the opening and the “Trap Doorz”, according to the preferred embodiment shown on FIG. 1.

FIG. 5 illustrates a general isometric view of the body article with the “Trap Doorz” closed, according to the preferred embodiment shown on FIG. 1.

Identical reference numerals on the drawings generally refer to the same elements on different figures. A first-time introduced numeral in the description is enclosed into parentheses.

### DESCRIPTION OF SAMPLE PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

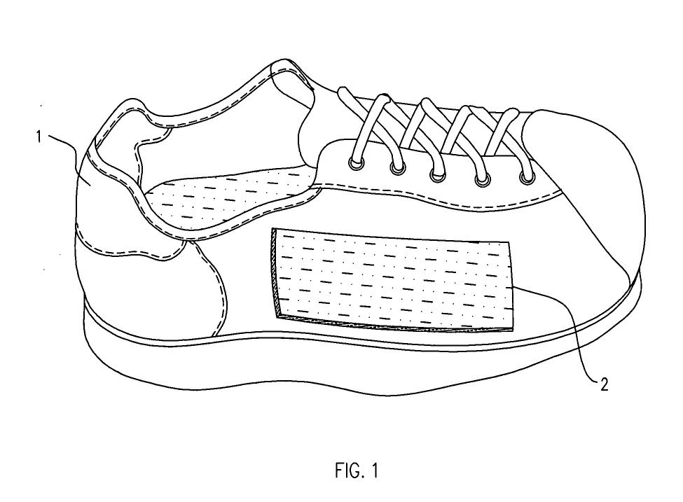

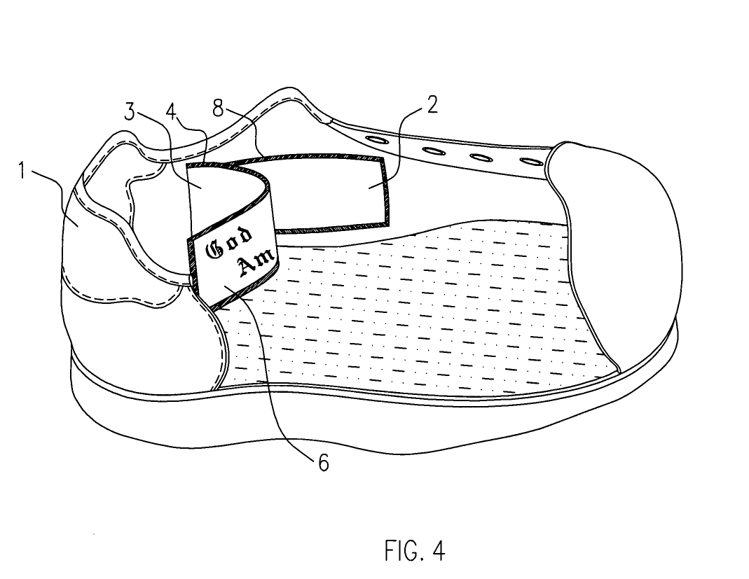

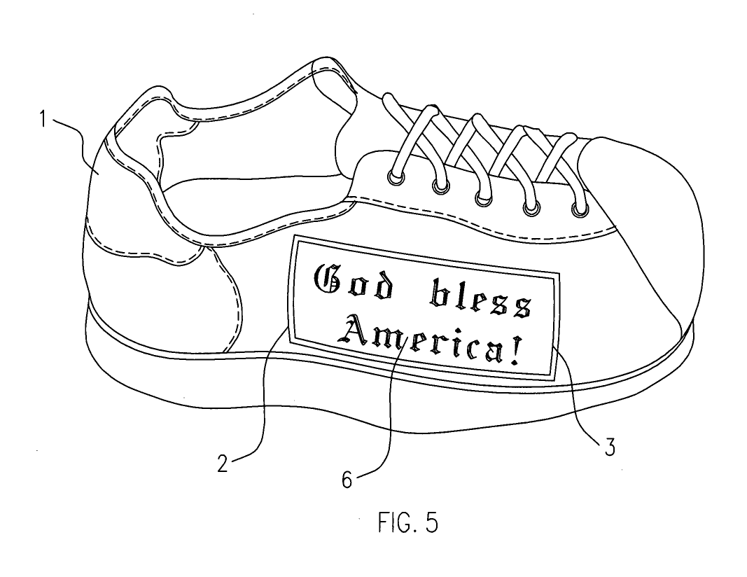

A preferred embodiment of a body article (1) (in this example, a snicker) according to the present invention is illustrated on FIG. 1. One of the lateral sides of the body article 1 has an opening (2). Exemplarily the opening 2 has a rectangular shape. The opening 2 is furnished with counterpart door locking means (8), attached to at least one edge of the opening 2, and shown on FIG. 4. In this example, the counterpart door locking means 8 are made as Velcro™ strips attached to and peripherally positioned along the edge perimeter of opening 2.

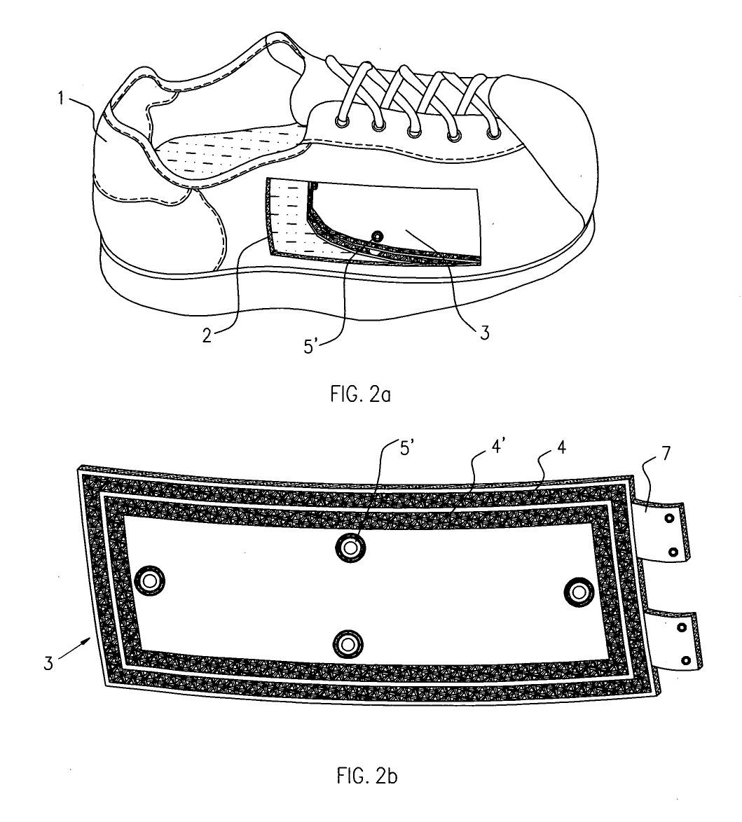

The body article 1 comprises a door member (3) shown on FIGS. 2a and 2b. The door member is preferably made of the same fabric as the body article. The door member 3 opens inside the body article, and has an inner face partially seen on FIG. 4 and an outer face depicted on FIG. 2b, and partially on FIG. 2a.

The door member 3 includes door locking means (4), in this example made as Velcro™ strip peripherally disposed on the outer face of member 3. The door locking means 4 is aligned with the counterpart door locking means 8, so that these two adhesive strips, when depressed against each other, can lock the door member 3.

The door member 3 includes indicia holding means (4′) and (5′). The indicia holding means 4′ and 5′ are disposed on the outer face of member 3, and respectively made as Velcro™ strips and as a number of male snaps both disposed closer to the center of member 3 than the door locking means 4.

The door member 3 includes hinge means (7) in this embodiment made as ‘soft hinges’ attached to one of the vertical sides of the door member 3 and to a corresponding side of the opening 2 (attachment to the opening 2 is not illustrated).

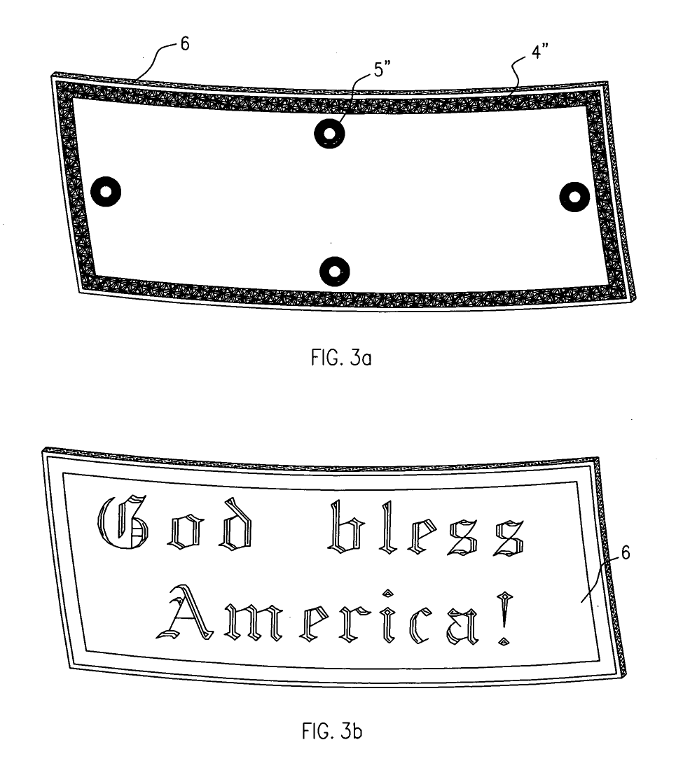

The body article 1 of this preferred embodiment comprises an indicia bearing plate (6), having an inward face depicted on FIG. 3a and an outward face depicted on FIG. 3b with indicia means, in this example, in the form of an engraved sign “God bless America!” On the inward face of the indicia plate 6 there are located counterpart indicia holding means (4″) and (5″), respectively made as peripherally positioned Velcro™ strips and as a number of female snaps (equal to the number of male snaps) aligned with the corresponding indicia holding means 4′ and 5′, so that the indicia plate 6 can be coupled to the door member 3 when the counterpart indicia holding means and the indicia holding means are depressed against each other.

The door member 3 can be opened by detaching it from the opening 2, unlocking the door locking means 4, and bringing the door member 3 into the open state. In the open state, one can replace a first indicia plate bearing the engraved sign with a second indicia bearing plate (e.g. having a red-blue-white pattern of the American flag, etc. on its outward face) by detaching the indicia holding means 4′ and 5′ of the first plate from the counterpart indicia holding means 4″ and 5″ of the door member 3, and attaching the indicia holding means 4′ and 5′ of the second plate to the counterpart indicia holding means 4″ and 5″ of the door member 3. Then one closes the door member 3 and it will be locked with the door locking means 4 and the counterpart door locking means 8 coupled together in the closed state.

In a modified embodiment (not illustrated), the indicia bearing plate can be incorporated into the door member (that is the indicia means are directly disposed on the outer face of the door member), so that such embodiment has neither indicia holding means, nor counterpart indicia holding means. Instead, the hinge means are removably fastened to the door member. By detaching the first door member from the hinge means, the user can replace the first door member, e.g. bearing a first logo, with a second door member, bearing a second logo. Therefore, the body article should be supplied with a set of additional door members bearing different signs, marks, logos, etc. to enable the user of interlocking them on the door member.

It should be understood that each of the elements described above, or two or more together, may also find a useful application in other types of constructions differing from the types described above.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

We claim:

1. A body article combinable with a piece of clothing, footwear, etc., capable of displaying indicia means, such as signs, logos, brand/trade marks, said body article comprising:
an opening furnished with counterpart door locking means attached to at least one edge of the opening;
hinge means having first ends, attached to an edge of the opening, and second ends;
a door member capable to open inside the body article, said door member attached to the second ends of said hinge means, said door member having an outer face, said door member including:
door locking means attached to the outer face of said door member and so disposed that aligned with said counterpart door locking means enabling their releasable coupling, and
indicia holding means attached to the outer face of said door member;
an indicia bearing plate having an outward face and an inward face, the indicia bearing plate including:
counterpart indicia holding means attached to the inward face, and aligned with said indicia holding means enabling their releasable coupling; and
indicia means disposed on the outward face for display.

2. A body article combinable with a piece of clothing, footwear, etc., capable of displaying indicia means, such as signs, logos, brand/trade marks, said body article comprising:
an opening furnished with counterpart door locking means attached to at least one edge of the opening;
hinge means having first ends, attached to an edge of the opening, and second ends;
a door member capable to open inside the body article, said door member releasably attached to the second ends of said hinge means, said door member having an outer face, said door member including:
indicia means disposed on the outer face for display.
